(19) United States
(12) Patent Application Publication
(10) Pub. No.: US 2026/0300811 A1
(43) Pub. Date: Oct. 1, 2026

(54) SUPPORTING DOMAIN DRIFT IN EDGE DEVICE NETWORKS VIA COMMUNITY DETECTION

(71) Applicant: Dell Products L.P., Round Rock, TX (US)

(72) Inventors: Diego Vrague Noble, Pelotas (BR); Eduardo Vera Sousa, Niterói (BR); Karen Braga Enes, Belo Horizonte (BR); Karen Stéfany Martins Zuin, Belo Horizonte (BR)

(21) Appl. No.: 19/094,320

(22) Filed: Mar. 28, 2025

(51) Int. Cl. G06N 20/00; G06F 18/23

(52) U.S. Cl. CPC G06N 20/00; G06F 18/23

(57) ABSTRACT

Techniques for identifying and correcting domain drift in an edge node are disclosed. A service identifies edge nodes of a network. The service determines that a first edge node has experienced domain drift. As a result, the first machine learning (ML) model of the first edge node is consuming data from a new domain. The edge nodes are clustered into at least a first and second community based on domain attributes. The first community is associated with a first domain, and the second community is associated with a second domain. The service determines that the new domain of the first ML model corresponds to the first domain. The service either deploys a common ML model used by edge nodes in the first community to the first edge node or, alternatively, retrains the first ML model using domain data of the first community.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to correcting domain drift. More particularly, at least some embodiments relate to systems, hardware, software, computer-readable media, and methods for identifying when an edge node has started to consume data from a new domain and for updating the edge node to account for this domain drift.

### BACKGROUND

Machine learning algorithms rely on input data for the learning process to be effective. In many cases, the learning process is improved if the training data is labeled. It is not uncommon, however, for the volume of labeled data to be small or non-existent and very costly to obtain.

Another common problem in machine learning applications is that environments are usually dynamic and thus, data changes over time. In this case, the effectiveness of the models can often be impacted by these changes in the data, because the models tend to adapt to the training data conditions. “Domain drift” (aka “concept drift”) refers to the problem related to changing data conditions that impact the effectiveness of machine learning models.

There is a possibility, however, that as the domain drift occurs, other models deployed in edge devices across the network contain more suited data to the new domain. Searching for this other data, however, has been quite a challenging task.

As used herein, the phrases “edge device” and “edge node” refer to a computing device that is positioned at the outer region or edge of a network. The terms “device” and “node,” as used herein, can be used interchangeably. Typically, edge devices are relatively close to a data source (e.g., a client device). Edge devices, due to their proximity to the client device, can beneficially process data near the source or origin of the client data, thereby leading to reductions in latency as there is no need to relay information to a distant server and wait for its response.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example computing architecture structured to identify and correct edge node domain drift.

FIGS. 2A and 2B illustrate various different groupings or communities of edge nodes.

FIG. 3 illustrates aspects of an edge node.

FIG. 4 illustrates a mapping between edge nodes and models.

FIG. 5 illustrates an example of a computing network.

FIG. 6 illustrates different communities of edge nodes.

FIG. 7 illustrates a table outlining information about nodes and communities.

FIG. 8 illustrates an example chart that is plotting domain drift.

FIG. 9 illustrates a flowchart of an example method for correcting edge node domain drift.

FIG. 10 illustrates an example computer system that can be configured to perform any of the disclosed operations.

### DETAILED DESCRIPTION

At least some of the disclosed embodiments are beneficially directed to a pipeline structured to recover from domain drift in an edge node scenario. Some of the disclosed embodiments rely on “community detection” and “active search” based strategies (to be discussed in more detail later).

Once a domain drift is identified in a model, some embodiments apply a community detection (CD) algorithm to cluster edges, which have corresponding machine learning models, with similar previously seen domains. Additionally, if necessary, it is possible to monitor and track the movement of edges between communities as domain drifts are identified to check if the model is still associated with the same community across time. To correct domain drift, some embodiments identify in which community the drifted model is inserted. After this community is found, some embodiments apply an active search solution in order to determine which node contains the labeled data or the relevant model needed to improve the learning process.

At least some of the disclosed embodiments thus beneficially address the following problems. One problem relates to the recognition that data searching in the entire network is costly and inefficient. Often, it is desirable to ensure data availability while reducing network traffic, and the embodiments achieve these desirable objectives. Another problem relates to finding different domains in different models. This operation is not a trivial task and may require a search over the entire network, which is often unfeasible. Another problem occurs in the scenario where a domain drift does occur. In such a scenario, it is desirable for the correction to be made as soon as possible to avoid a significant decrease in model performance.

At least some of the disclosed embodiments beneficially leverage edge device networks in a decentralized scenario to provide a solution for identifying and improving robustness in a case of domain drift. In some scenarios, the disclosed solution makes a number of assumptions. One assumption is that edge devices are connected in a network that can be modelled as an undirected graph. Another assumption (e.g., for sake of simplicity) is that the embodiments assume each node or edge device contains only one model, which allows terms recited in this disclosure to be used interchangeably. In practical terms, the embodiments are aware that one edge device may contain multiple models deployed in it, which does not imply a loss of generality. Another assumption is that models and edge devices can be grouped according to their already known domains. This grouping is called domain-based community grouping.

Notice that the domain-based community is just a view of the network. In practice, the network connections are not rebuilt, so the cost relies only on running the community detection algorithm. In other words, there is no cost associated with a possible remapping of the network. Also, edge devices can benefit from directly exchanging information with their domain-based grouping of devices. It is also the case that the community orchestrator server maintains an up-to-date community-based map of the network.

At a high level, at least some of the embodiments work as follows. After drift detection is run for each model and edge device, the data about this device is sent to the community orchestrator server (S). Notice that despite suggesting a method to better describe the context, various drift detection methods can be used.

After the above process, a number of operations are performed. First (1), the community orchestrator server (S) receives data from all edge devices. Second (2), the community detection algorithm is run. Third (3), for each model that changed its community (i.e., drifted), a number of suboperations are performed.

Specifically, in sub-step (a), if the drifted model belongs to a community with at least one node, the embodiments first (i) apply active search in the community nodes in order to find a shared model or labeled data samples to improve the model. Notice that the number of nodes is now considerably smaller than the full network, since the community is a subset of the full network. Next, the process returns to step 1 above.

Otherwise, another sub-step (b) is that the model is probably starting a new community and there is no shared model or labeled data related to it yet. In other words, there is nothing to do. As such, the process returns to step 1 above.

In this manner, the disclosed embodiments bring about numerous benefits, advantages, and practical applications in how edge nodes in a network are managed. For instance, at least some of the disclosed embodiments are beneficially directed to an approach that enables the sharing of models and labeled data from different domains between edges quickly and without the need to keep up-to-date information on a central server. As another benefit, at least some of the embodiments quickly find such data without relying on searching in the entire network, which impacts considerably on the data transferring and the recovery time from a model drift.

Some embodiments also beneficially provide a framework to recover from domain drift based on community detection. Additionally, at least some embodiments beneficially provide a node tracking strategy for community changes (i.e., domain changes) that could enable dynamic routing strategies to reduce the network latency if a node remains unchanged fora large number of iterations.

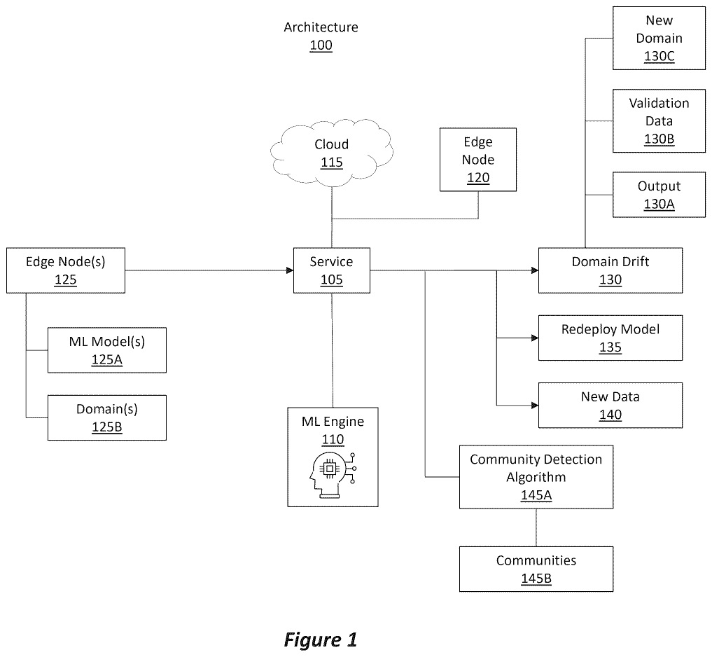

Having just provided some context information and some details regarding some of the benefits and advantages provided by the disclosed embodiments, attention will now be directed to FIG. 1, which illustrates an example architecture 100 in which the disclosed principles may be employed. Architecture 100 shows a service 105, which can be implemented as the “orchestrator” mentioned earlier.

As used herein, the term “service” refers to an automated program that is tasked with performing different actions based on input. In some cases, service 105 can be a deterministic classifier that operates fully given a set of inputs and without a randomization factor. In other cases, service 105 can be or can include a machine learning (ML) or artificial intelligence engine, such as ML engine 110. The ML engine 110 enables service 105 to operate even when faced with a randomization factor.

As used herein, reference to any type of machine learning or artificial intelligence (or large language model (LLM)) may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a local service operating on a local device, such as an edge device 120. In some implementations, service 105 is a cloud service operating in a cloud 115 environment. In some implementations, service 105 is a hybrid service that includes a cloud component operating in cloud 115 and a local component operating on a local device, such as the edge device 120. These two components can communicate with one another.

Service 105 is generally tasked with identifying a set of edge node(s) 125 and then determining whether domain drift 130 has occurred in one or more of those edge node(s) 125. In response to detecting the domain drift 130, service 105 can perform various corrective actions to account for the domain drift 130. As one example, service 105 can identify which new community a device is now associated with. Service 105 can obtain the model the devices in that community are using and then redeploy that model (e.g., as shown by redeploy model 135) to the drifted edge node. The drifted edge node can then use the redeployed model.

In another scenario, service 105 can permit the drifted edge node to continue to use its existing model. Service 105 can obtain the input data or other training data used by the edge nodes in the new community that the drifted node is now a part of. Service 105 can then cause the model on the drifted device to be trained, retrained, or fine-tuned using the acquired data from its neighbors, as shown by new data 140.

Accordingly, service 105 can be tasked with identifying a set of edge nodes (e.g., edge node(s) 125) operating in a network. Each of at least some of the edge node(s) 125 includes a corresponding machine learning (ML) model, as shown by ML model(s) 125A. Some of the edge node(s) 125 may be operating across different domain(s) 125B.

Service 105 determines that a first edge node in the set of edge nodes has experienced domain drift 130. The process of determining that the first edge node has experienced domain drift 130 is performed by comparing an output 130A of a first ML model of the first edge node against validation data 130B stored on the first edge node. The result of this comparison indicates that the first ML model is consuming data from a new domain 130C that is different from an original domain (e.g., one of the domain(s) 125B) of the first ML model.

Service 105 applies a community detection algorithm 145A to cluster the set of edge nodes into at least a first community and a second community (e.g., as shown by communities 145B). This clustering is performed based on domain attributes. Notably, the first community is associated with a first domain, and the second community is associated with a second domain.

Service 105 also determines that the new domain of the first ML model corresponds to the first domain. As a result, the first edge node has drifted into the first community.

Service 105 either deploys a common ML model used by edge nodes in the first community to the first edge node (e.g., as shown by redeploy model 135) or, alternatively, retrains the first ML model using domain data of the first community (e.g., as shown by new data 140). Further details on these operations will be provided later. At this point, some additional context, provided below, is beneficial to further understand the disclosed principles.

Graphs are mathematical structures used mainly to represent relationships (e.g., edges) between entities (e.g., vertices or nodes). These powerful structures can be used to model a large number of problems. In many of these applications, the vertices (e.g., nodes) of a graph can contain valuable information about the entities being modeled on these structures. This set of information about the modeled entities is called a node's attributes. In addition, the vertices of a graph may have special characteristics (e.g., labels) that make them the target for some tasks.

“Search” in graphs refers to the process of traversing a graph, a subgraph, or a set of interconnected nodes to find one or more specific nodes or paths. Graph search refers to a class of algorithms that systematically explore the nodes and edges of a graph, computing many interesting properties.

In many real networks, searching in a graph or accessing data associated to nodes and edges of the network is often difficult and querying nodes can have a steep cost. In these scenarios, it is often the case that a large fraction of the data to be modeled is unobserved, and it is often the case that only a limited budget is available to perform queries. Moreover, some scenarios may not be interested in the complete network, but only in a set of target nodes (e.g., nodes with certain characteristics).

As an example, consider the problem of finding as many Facebook users that share a particular taste in music as possible, starting from a specific user's friendship network. Here, Facebook users are nodes, friendship statuses are edges, and musical tastes are attributes of a user. Except for the Facebook engineers themselves, access to the networks is limited, and it is very challenging (if not impossible) to query all nodes of the network.

Active search on graphs is a technique to find the largest number of target nodes (i.e. nodes with a certain label) in a network by querying nodes in a graph, under a query budget constraint. Nodes have hidden labels, but the network topology and edge weights are fully observable, and any node can be queried at any time. Active search is an increasingly relevant learning problem in which the embodiments can beneficially use a limited budget of label queries to discover as many members of a certain class as possible.

One of the primary objectives of active search algorithms is to uncover as many target nodes as possible using the least number of queries to the graph interface. The network topology and edge weights are fully observable at any time but target nodes (i.e., nodes with a certain label) have their labels hidden. The node's label(s) are revealed after querying the graph interface. Since it is desirable to minimize the number of queries while maximizing the uncover of target nodes, active search techniques operate under a budget. Alternatively, the budget can be considered a proxy to the number of queries allowed to be made to the network. A typical algorithm builds a model from the labels already collected and iteratively uses it to select the next point for labeling that is expected to most improve the model.

A common phenomenon in networks is the emergence of regions of heavily interconnected nodes. These graph clusters are called “communities.” More specifically, this common kind of community is called “assortative community.” There are countless mechanisms by which connections are established in networks. The most common mechanism is homophily, which is present when a new node in the network prefers to connect to similar nodes according to a criterion. For instance, new nodes may form a community in a computer network because they connect to the geographically closer switch.

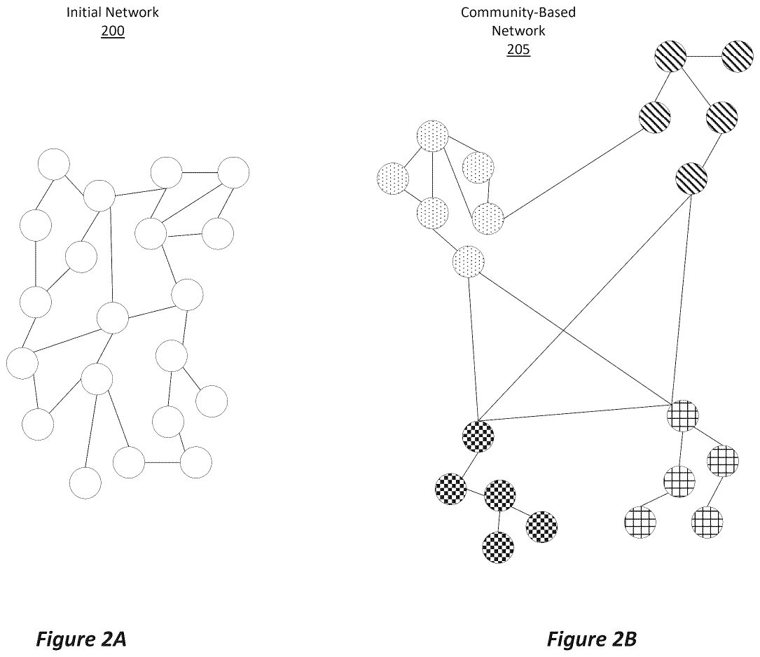

FIG. 2A portrays an initial network 200 that is not organized into a community structure. FIG. 2B, on the other hand, shows the nodes of the initial network 200 now organized into four different communities, thereby forming the community-based network 205. Each community in FIG. 2B illustrates its nodes using a common circular fill (e.g., a dot pattern, an angled line pattern, and cross checkered patterns). Although illustrated in a simplified form in FIG. 2B, there is actually a high-density of connections among nodes of the same community.

Community detection (CD) algorithms include the Girvan-Newman algorithm, which explores Freeman's Betweenness Centrality of edges to detect communities or the hierarchical clustering family of algorithms that can detect hierarchies of communities. Alternative algorithms can perform CD in dynamic and heterogeneous networks.

At this point, it will be helpful to present an example application of the disclosed solutions in more detail. As an application example, consider, for instance, a scenario in which multiple autonomous cars are modeled in a network of multiple edge devices. Each car can have different devices (e.g., smart cameras), and each device can run machine learning models trained on a specific domain (e.g., object detection model to recognize vehicles and pedestrians in the street). Frequently, a car trained to a specific scenario, such as tropical climate, needs to adapt its models to run in other regions/environments (e.g., a snow falls environment).

Service 105 of FIG. 1 can be tasked to solve this problem. First, service 105 identifies the domain drift. For example, consider that a car trained in Brazil was transferred to Siberia. As the car is moving in its new environment, it collects data (e.g., camera images) that can be used to identify the domain drift. After identifying the drift (i.e., a new domain is being presented to the model), service 105 searches for other cars in the network having shared models in a similar domain. This operation is performed to avoid retraining a model.

If no shared model is found, service 105 can search the network for labeled data to train its existing model. In other words, service 105 can adapt the object detection model, trained to recognize vehicles and pedestrians in a tropical climate domain, to recognize the same objects in the winter using data from other cars in Siberia. In this way, service 105 can use data from the network to improve the car's models.

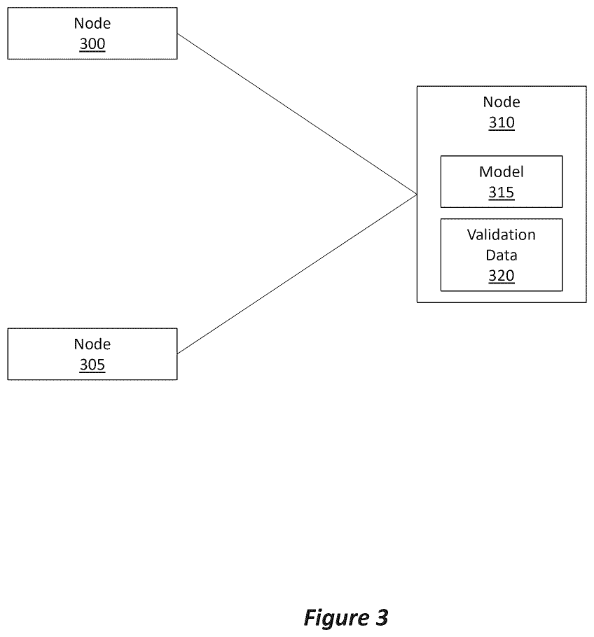

Formal aspects of some of the disclosed embodiments will now be described in more detail. First, consider a connected network that is modelled as an undirected graph, where each node represents an edge device. Here, it is possible to now refer to an edge device only as device so as to disambiguate from a graph edge. FIG. 3 depicts those concepts considering a network with three devices (e.g., node 300, node 305, and node 310). Model 315 is deployed on node 310, and the model 315 can use validation data 320. Optionally, the validation data 320 can be used to determine whether the node 310 has experienced domain drift.

Worthwhile to note is the concept of domain. Each device/node (e.g., nodes 300, 305, and 310) runs a machine learning model (e.g., model 315) that considers an already known domain Dₖ. The term “domain” refers to the specific knowledge area covered by a given model/dataset.

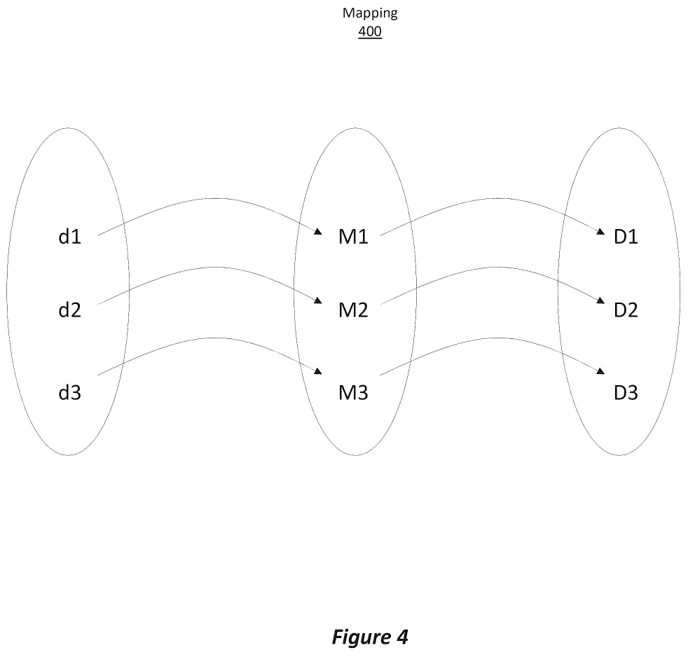

FIG. 4 depicts the mapping between the devices, the models and the domains as adopted in this embodiment. In it, each device dₖ is linked to a unique model Mₖ that was trained with the data from a unique domain Dₖ. Additionally, each device dₖ contains a small validation dataset vi, which is used for two tasks: detecting model drift and estimating the similarity between a pair of domains. FIG. 4 shows an example mapping 400 between devices/nodes (e.g., nodes 300, 305, and 310 of FIG. 3), models (e.g., model 315 of FIG. 3), and domains.

The devices, initially presented in a network structure, can be grouped in a domain-based community. Notice that the community is just a view from the original graph, so it does not change physically the network connections. Notice, however, that tracking data related to the frequency that a device moves from a community to another can be used as criteria for building a dynamic routing solution, where routes between nodes can be created in order to reduce connection jumps between the nodes.

One notable concept when building communities based on domains is the metric for domain similarity. Considering the small validation dataset vi present in each device, any metric for estimating similarity between a pair of distribution can be used, such as the Kullback-Leibler (KL) divergence, for example. The KL divergence is described as follows:

$${D}_{KL} ( a ‖ b ) = \sum a ln \frac{a}{b}$$

Notice, however, that the embodiments are associating an asymmetric measure with a community detection algorithm, which could lead to different results depending on the ordering the algorithm selects a pair of nodes for comparison. Thus, a more precise measurement could be the Jensen-Shannon (JS) divergence, defined in as follows:

$${D}_{JS} ( p ‖ q ) = \frac{1}{2} {D}_{KL} ( p ‖ \frac{p + q}{2} ) + \frac{1}{2} {D}_{KL} ( q ‖ \frac{p + q}{2} )$$

In at least some embodiments, JS divergence is used in two different comparisons. One comparison is the community detection execution, which allows for the estimation as to how similar two model domains are by comparing the output data of those two different models considering the validation data vi stored in each device. This comparison is performed during the community detection.

Another comparison is the drift detection, which allows the embodiments to detect model drift by comparing the model output considering the validation data stored in the device and the data received from the machine learning application to run inference. This comparison is performed on inference time to track model drift.

For the community detection algorithm, at least some of the embodiments rely on a label propagation approach (sometimes also called “epidemic community detection”) to determine the community a node belongs to in real time. It has been shown that this algorithm can achieve real-time community detection with high accuracy even in large graphs, such as 1 million nodes and 58 million directed edges. In the present use case, some embodiments use the distribution (p or q in the D_{JS} formulation) as node attribute and the D_{JS} itself as comparison method for label propagation.

By doing this, the embodiments can group models with a set of similar domains in the same community. Notice that grouping models/edge devices into communities according to known domains generates a subset of devices where one can search for labeled data or shared models more easily. In practical terms, by clustering edge devices into communities, the embodiments are pruning the search space for labeled data or shared models. Additionally, it is worthwhile to notice that domain-based communities may not match network-based communities, since there are two different criteria for the community detection algorithm.

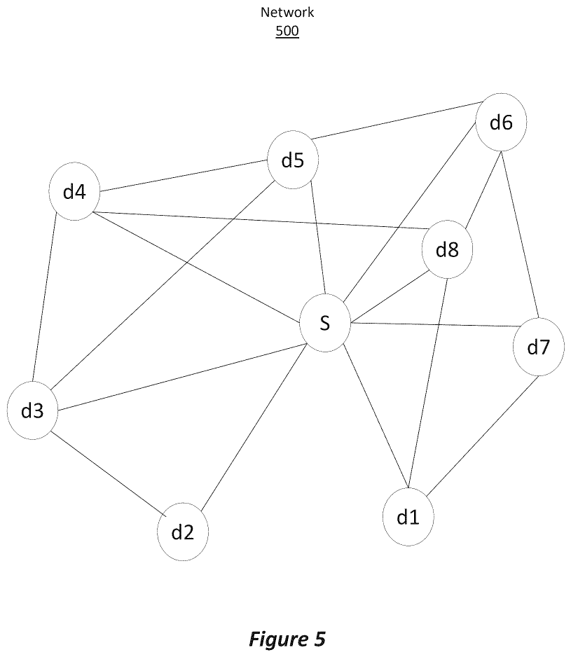

FIG. 5 shows an example network 500, where each node represents a device (dₙ). To make the explanations easier, the embodiments are considering that each device contains only one model.

FIG. 5 depicts a possible embodiment for the network architecture explored herein, where all the devices, represented by the set N={dᵢ}^{k}ᵢ₌₁ with k=8, are connected to a community orchestrator server (represented by the device S). When a model detects a drift scenario (using D_{JS}), this information is pushed to S, which runs the domain-driven community detection to build the communities. In this step, the embodiments check the community Cₓ|Cₓ ∈C where the drifted node nᵢ is now inserted. The embodiments can assume, for the sake of simplicity, that a community contains information about only one domain. In practical terms, given two sets C, which refer to the set of communities, and D, which refers to the set of domains, it is possible to say that both sets have the same cardinality, i.e., |C|=|D|.

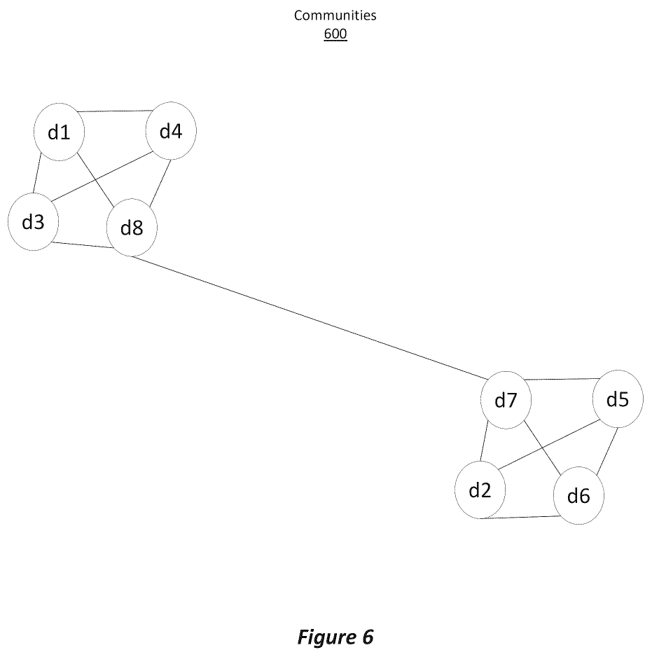

FIG. 6 shows one possible scenario of the domain-based communities 600 of the graph presented in FIG. 5. Notice that this is just a view from that graph, so the cost relies only in running the community detection algorithm. In other words, it is not required to create physical network connections between the devices.

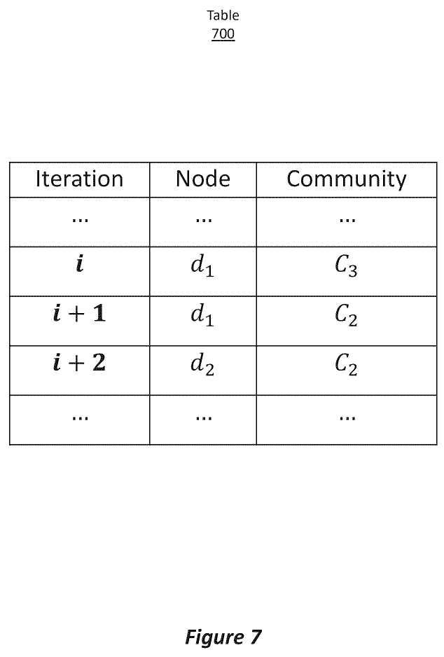

FIG. 6 depicts the domain-based communities 600 (device S is implicit but it is connected to all the nodes) from the same network presented in FIG. 5. One of the byproducts of this approach relies on tracking a device's historical data with regards to the communities, where it is possible to keep information about the device and its associated community at a given iteration i. An example is present in Table 700 shown in FIG. 7.

By using this data, stored in S, the embodiments can check how long a device remained in the same community, which could be a feature to determine if it is worth improving the network routing map in this device and reduce the network latency. This approach is particularly advantageous for the dynamic routing solution.

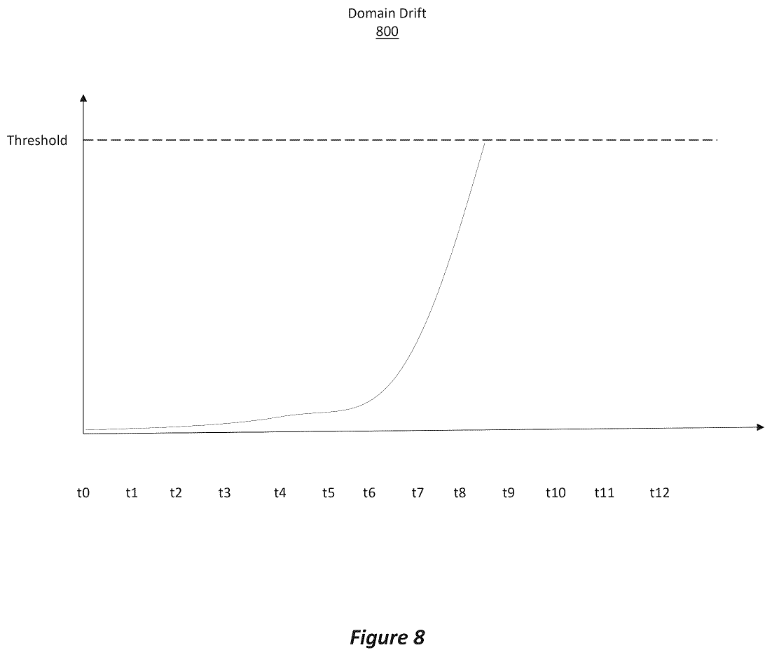

Regarding detecting domain drift, one goal of this phase is to identify if a device (model) has started consuming data from a different domain. For the first step of this phase (i.e. detecting domain drift, aka Phase 1), a device on the network receives a data batch to perform an inference. For each inference executed in a given timestamp, service 105 of FIG. 1 accumulates the divergence computed using D_{JS}, where the distributions used as parameters are the computed from the validation dataset vi and the inference batch. If the accumulated divergence reaches a threshold t, service 105 flags this model as a drifting model so Phase 2 (i.e. recovering from domain drift) is executed. FIG. 8 depicts this process, as shown by domain drift 800, where the data behavior starts to change at timestamp t₄ and reaches the drifting threshold after t₈.

Notice that different methods for detecting domain drift can be used here, since service 105 is not necessarily interested in the specific details of the domain drift approach. Domain drift detection can be done at the edge (if there are sufficient resources) or in the orchestrator, which provides flexibility to the framework. The information about the occurrence (or not) of domain drift and the devices (models) where it occurred are then pushed to the community orchestrator server (S), alongside with a list of domains Dᵢ. This step triggers the graph community detection algorithm explored next.

Regarding Phase 2 (i.e. recovering from domain drift), one objective of this phase is to find models with similar domains to allow data/model sharing between them. The first step is to receive data from all devices with its list of domains Dᵢ for each model Mi, alongside with the data distribution of each model, which allows service 105 to compare the distributions using D_{J}s. This step can optionally be performed by the community orchestrator server S or service 105. In the second step, the embodiments effectively run the community detection algorithm to group devices according to their domains. After that, the embodiments update the device's historical data, in the same format as presented in Table 700 of FIG. 7. Based on that, the embodiments add the devices that changed domains in this last iteration to a list L.

Finally, for each device I in L, service 105 searches the domain community for a shared data/model. This is a great improvement when compared to naively searching the whole graph.

A comparison between FIGS. 5 and 6 helps to illustrate how FIG. 6 depicts the significant reduction in search space as domain drift is detected and tackled. FIG. 6 emphasizes the search space for the shared data/model to allow recovering from the drift. In this example, consider that the model deployed in d₅ has drifted. Instead of searching in 7 devices, service 105 reduces the search space to only 3 devices (e.g., devices d₇, d₆, and d₂).

Notice, however, that searching for data in a large set of nodes, depending on the community size, can be an unfeasible task. Thus, the embodiments rely on a strategy for a guided graph search, namely, active search, where the neighborhood of a given node is evaluated based on a classifier built upon the probability of a node to contain information or not.

If there is at least one target node, the embodiments return the deployed model to the device I. If the model is tagged as non-shareable, the embodiments aim for shared labeled data to be returned to device I. Otherwise, if no model or data are shareable in this new domain, then a new model is trained and deployed. In a situation where no shareable data or model is found in a community, then it is likely the case that this community is new. Accordingly, the disclosed techniques allow the embodiments to quickly recover a set of models deployed in edge devices from domain drift, thereby providing stability and generalization for these models.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

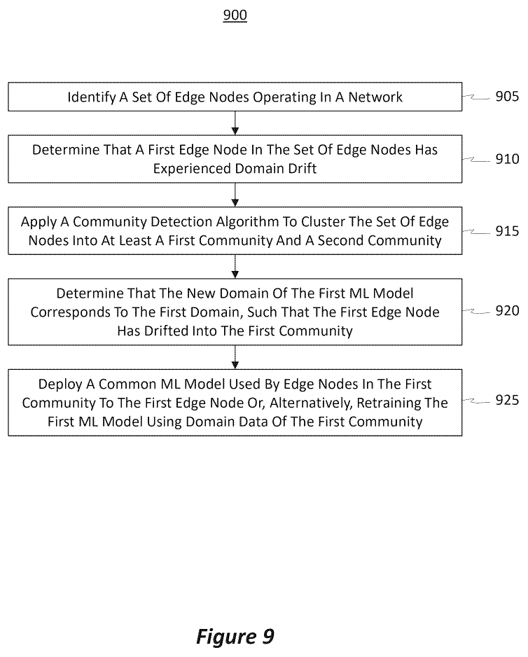

Attention will now be directed to FIG. 9, which illustrates a flowchart of an example method 900 for identifying and correcting domain drift in an edge node. Method 900 can be implemented within architecture 100 of FIG. 1. Method 900 can be performed by service 105, which can optionally be the orchestrator mentioned herein.

Method 900 includes an act (act 905) of identifying a set of edge nodes operating in a network. Each of at least some of the edge nodes in the set of edge nodes includes a corresponding machine learning (ML) model.

Act 910 includes determining that a first edge node in the set of edge nodes has experienced domain drift. Determining that the first edge node has experienced domain drift is performed by comparing an output of a first ML model of the first edge node against validation data stored on the first edge node. A result of this comparison indicates that the first ML model is consuming data from a new domain that is different from an original domain of the first ML model.

Act 915 includes applying a community detection algorithm to cluster the set of edge nodes into at least one first community and a second community. This clustering operation is performed based on domain attributes. Notably, the first community is associated with a first domain, and the second community is associated with a second domain.

Act 920 includes determining that the new domain of the first ML model corresponds to the first domain. As a result, the first edge node has drifted into the first community.

Act 925 includes deploying a common ML model used by edge nodes in the first community to the first edge node or, alternatively, retraining the first ML model using domain data of the first community.

Optionally, method 900 further includes applying an active search algorithm to the first community in an attempt to find the common ML model or the domain data. Here, the domain data is labeled data.

As another option, method 900 includes first attempting to identify and deploy the common ML model used by edge nodes in the first community to the first edge node. In response to a failed attempt to identify and deploy the common ML model, method 900 includes retraining the first ML model using the domain data of the first community.

In some scenarios, the community detection algorithm clusters the set of edge nodes into at least the first community and the second community based on a domain similarity metric. Optionally, the first and second communities, which are based on domain similarities, do not match network-based communities.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, classifiers, and component are examples of terms that may refer to software objects or routines that execute on the computing system. The different components, modules, engines, services, and classifiers described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

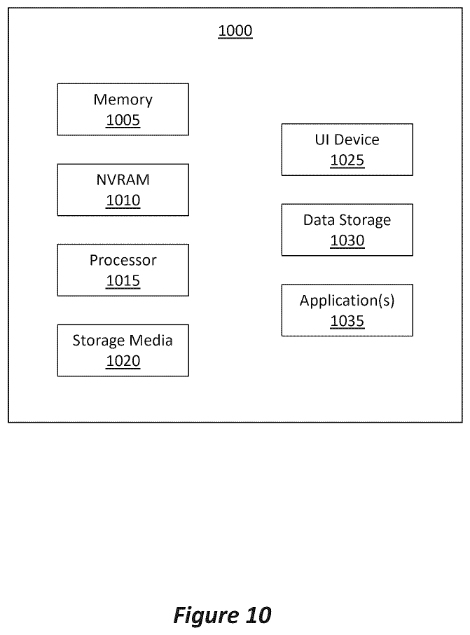

With reference briefly now to FIG. 10, any one or more of the entities disclosed, or implied, by the Figures and/or elsewhere herein, may take the form of, or include, or be implemented on, or hosted by, a physical computing device, one example of which is denoted at 1000. This example device can be implemented in architecture 100 of FIG. 1 and can host service 105. Also, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1005 which may include one, some, or all, of random access memory (RAM), non-volatile memory (NVM) 1010 such as NVRAM for example, read-only memory (ROM), and persistent memory, one or more hardware processors 1015, non-transitory storage media 1020, UI device 1025, and data storage 1030. One or more of memory 1005 of the physical computing device 1000 may take the form of solid-state device (SSD) storage. Also, one or more applications 1035 may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 1000 may also be representative of an edge system, a cloud-based system, a datacenter or portion thereof, or other system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
identifying a set of edge nodes operating in a network, wherein each of at least some of the edge nodes in the set of edge nodes includes a corresponding machine learning (ML) model;
determining that a first edge node in the set of edge nodes has experienced domain drift, wherein determining that the first edge node has experienced domain drift is performed by comparing an output of a first ML model of the first edge node against validation data stored on the first edge node, and wherein a result of said comparing indicates that the first ML model is consuming data from a new domain that is different from an original domain of the first ML model;
applying a community detection algorithm to cluster the set of edge nodes into at least a first community and a second community, wherein said clustering is performed based on domain attributes, and wherein the first community is associated with a first domain and the second community is associated with a second domain;
determining that the new domain of the first ML model corresponds to the first domain, such that the first edge node has drifted into the first community; and
deploying a common ML model used by edge nodes in the first community to the first edge node or, alternatively, retraining the first ML model using domain data of the first community.

2. The method of claim 1, wherein the method includes deploying the common ML model used by edge nodes in the first community to the first edge node.

3. The method of claim 1, wherein the method includes retraining the first ML model using the domain data of the first community.

4. The method of claim 1, wherein the method further includes applying an active search algorithm to the first community in an attempt to find the common ML model or the domain data, and wherein the domain data is labeled data.

5. The method of claim 1, wherein the method includes:
first attempting to identify and deploy the common ML model used by edge nodes in the first community to the first edge node; and
in response to a failed attempt to identify and deploy the common ML model, retraining the first ML model using the domain data of the first community.

6. The method of claim 1, wherein the community detection algorithm clusters the set of edge nodes into at least the first community and the second community based on a domain similarity metric.

7. The method of claim 1, wherein the first and second communities, which are based on domain similarities, do not match network-based communities.

8. A computer system comprising:
one or more processors; and
one or more hardware storage devices that store instructions that are executable by the one or more processors to cause the computer system to:
identify a set of edge nodes operating in a network, wherein each of at least some of the edge nodes in the set of edge nodes includes a corresponding machine learning (ML) model;
determine that a first edge node in the set of edge nodes has experienced domain drift, wherein determining that the first edge node has experienced domain drift is performed by comparing an output of a first ML model of the first edge node against validation data stored on the first edge node, and wherein a result of said comparing indicates that the first ML model is consuming data from a new domain that is different from an original domain of the first ML model;
apply a community detection algorithm to cluster the set of edge nodes into at least a first community and a second community, wherein said clustering is performed based on domain attributes, and wherein the first community is associated with a first domain and the second community is associated with a second domain;
determine that the new domain of the first ML model corresponds to the first domain, such that the first edge node has drifted into the first community; and
deploy a common ML model used by edge nodes in the first community to the first edge node or, alternatively, retraining the first ML model using domain data of the first community.

9. The computer system of claim 8, wherein the instructions are further executable to cause the computer system to deploy the common ML model used by edge nodes in the first community to the first edge node.

10. The computer system of claim 8, wherein the instructions are further executable to cause the computer system to retrain the first ML model using the domain data of the first community.

11. The computer system of claim 8, wherein the instructions are further executable to cause the computer system to apply an active search algorithm to the first community in an attempt to find the common ML model or the domain data, and wherein the domain data is labeled data.

12. The computer system of claim 8, wherein the instructions are further executable to cause the computer system to:
first attempt to identify and deploy the common ML model used by edge nodes in the first community to the first edge node; and
in response to a failed attempt to identify and deploy the common ML model, retrain the first ML model using the domain data of the first community.

13. The computer system of claim 8, wherein the community detection algorithm clusters the set of edge nodes into at least the first community and the second community based on a domain similarity metric.

14. The computer system of claim 8, wherein the first and second communities, which are based on domain similarities, do not match network-based communities.

15. One or more hardware storage devices that store instructions that are executable by one or more processors to cause the one or more processors to:
identify a set of edge nodes operating in a network, wherein each of at least some of the edge nodes in the set of edge nodes includes a corresponding machine learning (ML) model;
determine that a first edge node in the set of edge nodes has experienced domain drift, wherein determining that the first edge node has experienced domain drift is performed by comparing an output of a first ML model of the first edge node against validation data stored on the first edge node, and wherein a result of said comparing indicates that the first ML model is consuming data from a new domain that is different from an original domain of the first ML model;
apply a community detection algorithm to cluster the set of edge nodes into at least a first community and a second community, wherein said clustering is performed based on domain attributes, and wherein the first community is associated with a first domain and the second community is associated with a second domain;
determine that the new domain of the first ML model corresponds to the first domain, such that the first edge node has drifted into the first community; and
deploy a common ML model used by edge nodes in the first community to the first edge node or, alternatively, retraining the first ML model using domain data of the first community.

16. The one or more hardware storage devices of claim 15, wherein the instructions are further executable to cause the one or more processors to deploy the common ML model used by edge nodes in the first community to the first edge node.

17. The one or more hardware storage devices of claim 15, wherein the instructions are further executable to cause the one or more processors to retrain the first ML model using the domain data of the first community.

18. The one or more hardware storage devices of claim 15, wherein the instructions are further executable to cause the one or more processors to apply an active search algorithm to the first community in an attempt to find the common ML model or the domain data, and wherein the domain data is labeled data.

19. The one or more hardware storage devices of claim 15, wherein the instructions are further executable to cause the one or more processors to:
first attempt to identify and deploy the common ML model used by edge nodes in the first community to the first edge node; and
in response to a failed attempt to identify and deploy the common ML model, retrain the first ML model using the domain data of the first community.

20. The one or more hardware storage devices of claim 15, wherein the community detection algorithm clusters the set of edge nodes into at least the first community and the second community based on a domain similarity metric.
